(19) United States
(12) Patent Application Publication
(10) Pub. No.: US 2015/0088619 A1
(43) Pub. Date: Mar. 26, 2015

(54) TECHNIQUES FOR PROCESSING CUSTOMERS AFFECTED BY INVOLUNARY DENIAL OF BOARDING

(71) Applicant: NCR CORPORATION, Duluth, GA (US)

(72) Inventors: Troy Larson, Alpharetta, GA (US); Jared K. Miller, Cumming, GA (US); William Ward, Cumming, GA (US); Webb Morris, Smyrna, GA (US)

(73) Assignee: NCR CORPORATION, Duluth, GA (US)

(21) Appl. No.: 14/038,243

(22) Filed: Sep. 26, 2013

(51) Int. Cl. G06Q 50/14; G06Q 30/02

(52) U.S. Cl. CPC G06Q 50/14; G06Q 30/0207
USPC 705/14.1

(57) ABSTRACT

Techniques for processing customers affected by involuntary denial of boarding which facilitate electronic storage of completed forms. An example method includes displaying terms of a compensation award to a customer affected by involuntary denial of boarding by a computer, recording an electronic signature of the customer by the computer, and storing the terms and the electronic signature in a data store by the computer. The method may further include issuing the compensation award in accordance with the terms.

### BACKGROUND

The present invention relates to travel systems, and more specifically to techniques for processing customers affected by involuntary denial of boarding.

Involuntary denial of boarding (IDB) occurs when an airline has oversold a flight and therefore has no seats remaining for one or more customers who have purchased tickets for the flight. Airlines typically ask for volunteers with seats on the flight to give up those seats so that customers without seats may become passengers on the flight. However, some customers without seats may still not become passengers on the flight.

Airlines are obligated to provide notice to customers who have been involuntarily denied boarding and to customers who have given up their seats. The notice explains the airline's obligations to these customers. Airlines typically rebook them on the next available flight and offer a travel voucher or other compensation award to such customers.

Current procedures for handling customers who have been involuntarily denied boarding or given up their seats involve paper forms. For example, when a customer accepts a travel voucher, the customer must sign a paper form. The airline must keep the signed form on file or be subject to fines imposed by law.

It would be desirable to provide an alternative method of processing customers affected by airlines that involuntarily deny boarding.

### SUMMARY

In accordance with the teachings of the present invention, techniques for processing customers affected by involuntary denial of boarding are provided.

An example method includes displaying terms of a compensation award to a customer affected by involuntary denial of boarding by a computer, recording an electronic signature of the customer by the computer, and storing the terms and the electronic signature in a data store by the computer. The method may further include issuing the compensation award in accordance with the terms.

### BRIEF DESCRIPTION OF THE DRAWINGS

FIG. 1 is a block diagram of an example travel system.

FIG. 2 is a flow diagram illustrating an example method of processing customers affected by involuntary denial of boarding.

### DETAILED DESCRIPTION

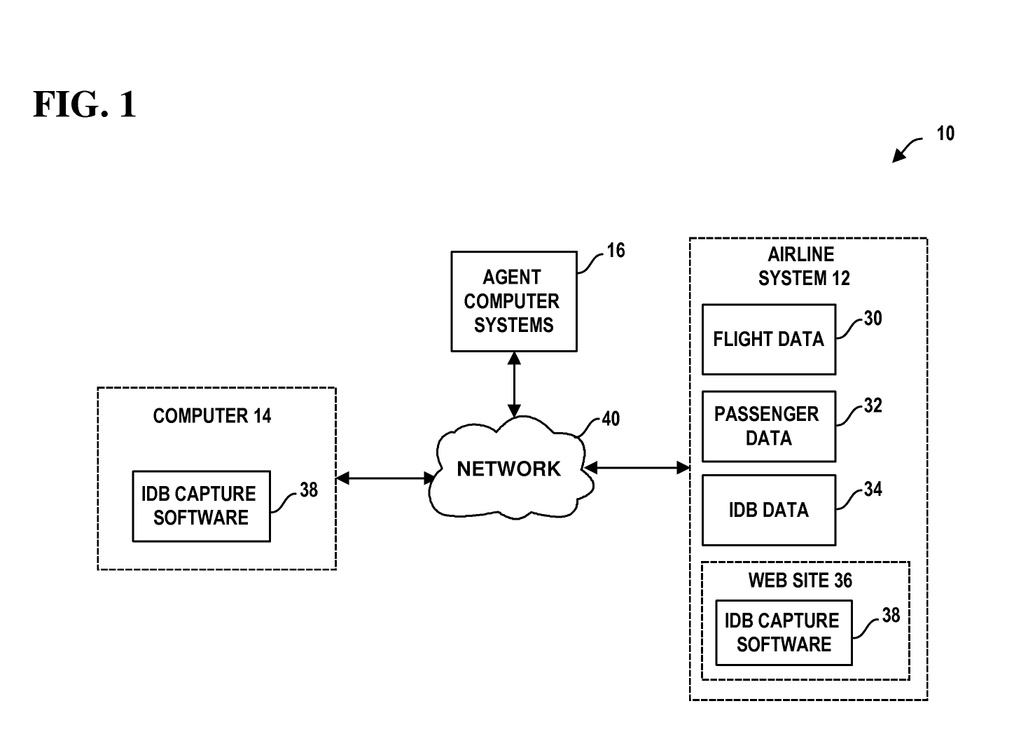

Turning now to FIG. 1, travel system 10 is illustrated in an air travel example. Other types of transportation methods and corresponding types of travel systems are also envisioned.

Example travel system 10 primarily includes one or more airline systems 12. Airline system 12 includes one or more servers including one or more processors, memory, and program and data storage. Airline system 12 may execute an operating system such as a Microsoft or Linux operating system. Airline system 12 further includes network circuitry for connecting to network 40, and may include other circuitry for connecting to peripherals, such as a display, a printer, a mouse, and a keyboard.

Network 40 may include any combination of wireless or wired networks, including local area, wide area, virtual private, and global communication networks, such as the Internet.

Airline system 12 maintains one or more databases containing flight data 30 and passenger data 32. Flight data 30 may include information about each scheduled flight. Passenger data 32 may include passenger identification information and other information associated with the passenger identification information, including travel document information. Travel documents may include passports or visas issued by government authorities, or other required travel documents. Travel document information may include passenger nationality, travel document number, travel document expiration, travel document issuing authority, or other required information. Airline system 12 may also include third part host computers that store and manage some of the flight data 30 and passenger data 32 in a Departure Control System (DCS) for an airline.

Airline system 12 may be connected to the web and include a web server which hosts a web site 36 including web pages, web applications and other web content. Passengers may visit web site 36 to make or change reservations and to check-in for flights.

Airline customers who have been affected by involuntarily denied boarding (IDB) may also visit web site 36 to obtain a travel voucher and/or other compensation award. For this purpose, web site 36 may include or provide IDB capture software 38.

IDB capture software 38 receives identifying information from a customer affected by IDB. IDB capture software 38 verifies the identifying information against passenger data 32 and/or flight data 30, including verifying that the customer was denied boarding. Example identifying information may include a confirmation number, a name, and/or a flight number.

IDB capture software 38 may receive the identifying information from any of a variety of example devices. For example, IDB capture software 38 may receive the identifying information entered by the customer using a touch screen.

As another example, IDB capture software 38 may receive the identifying information from a loyalty or credit card using a card reader.

As another example, IDB capture software 38 may receive the identifying information from a barcode on a boarding pass using a barcode reader.

As another example, IDB capture software 38 may receive the identifying information from a chip or machine readable zone of a passport or visa using a passport reader.

As another example, IDB capture software 38 may wirelessly receive the identifying information from a mobile communication device of the customer equipped with near field communication circuitry.

If the verification passes, IDB capture software 38 displays a notice of airline obligations and a compensation award form containing terms of compensation. IDB capture software 38 prompts the customer to enter an electronic signature. The electronic signature may be a signature applied via a stylus, the customer's typed name, or other entry signifying the customer's agreement with the terms of the compensation award. IDB capture software 38 captures the electronic signature and stores signed forms in IDB data 34.

IDB capture software 38 issues a travel voucher or other compensation award. For example, IDB capture software 38 may electronically provide the compensation award by adding a record of the award to passenger data 32.

As another example, IDB capture software 38 may print a document evidencing the award.

As another example, IDB capture software 38 may credit an amount of the award to a credit or other payment card account of the customer.

As another example, IDB capture software 38 may send an electronic document evidencing the award to the customer's email address, and/or transfer the electronic document to the customer's mobile communication device for storage through email, text message, near field communications, or other means.

It is envisioned that airlines may offer different types of awards and the amount and types of awards may vary among airlines. For example, an airline may issue an award of ‘airline dollars’ good only on flights with that airline. The same airline may issue a cash refund award if a customer decides to cancel travel.

IDB capture software 38 may be written in a programming language such as the Java programming and be hosted within browser software.

As another example, IDB capture software 38 may include a script, written in a scripting language such as JavaScript, combined with hypertext markup language (HTML) or other suitable web page language and hosted within browser software.

As yet another example, IDB capture software 38 may include a software applet written to be executed within an operating system of a host computer system.

Airline customers who have been involuntarily denied boarding use computer 14 to complete and sign the form. For this purpose, computer 14 may include a personal computer, kiosk, or wall-mounted computer located at the airport. In an alternative embodiment, the customers who have been involuntarily denied boarding may complete and sign the form remotely, using a personal computer or mobile communication device, such as a smart phone, personal digital assistant, tablet computing device, or other portable communication device.

Computer 14 may include one or more processors, memory, and program and data storage. Computer 14 may execute an operating system such as a Microsoft, Google, or Apple operating system. Computer 14 may execute other computer software, which may be stored in a computer readable medium, and which may include web browser software to display web pages from airline system 12 and IDB capture software 38. Computer 14 further includes wired and/or wireless network circuitry for connecting to airline system 12 through network 40, and includes other circuitry for connecting to peripherals, such as a touch screen (or a display, keyboard, and mouse), and a printer. Computer 14 may further include one or more of a card reader, a barcode reader, a near filed communication reader, and a passport reader.

Example travel system 10 further includes agent computer systems 16 at terminal check-in and/or gate locations. In addition to other check-in functions, agent computer systems 16 may assist agents in making decisions regarding which airline customers will be denied boarding and which customers will receive compensation awards, and in processing compensation awards for these customers.

Agent computer systems 16 each include one or more processors, memory, and program and data storage. Agent computer systems 16 may execute an operating system such as a Microsoft or Linux operating system. Agent computer systems 16 further include network circuitry for connecting to network 40, and may include other circuitry for connecting to peripherals, such as a touch screen or display, keyboard, and mouse.

In an alternative embodiment, the functions of computer 14 may be combined into agent computer systems 16. Each of agent computer systems 16 may include a second display and associated peripherals facing the customer for completing IDB procedures with attendant assistance.

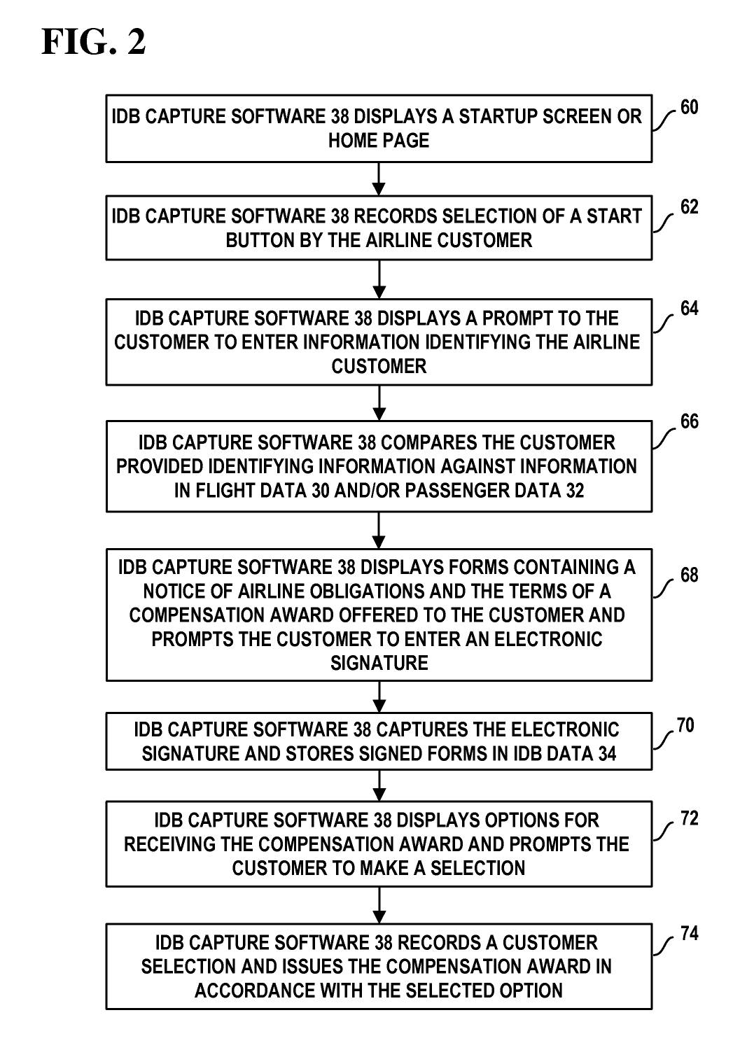

With reference to FIG. 2, an example IDB method is illustrated beginning with step 60. The example method facilitates self-service processing of customers affected by involuntary denial of boarding and electronic storage of completed forms.

In step 60, IDB capture software 38 displays a startup screen or home page with selection buttons to begin IDB processing by an airline customer using computer 14.

In step 62, IDB capture software 38 records selection of a start button by the airline customer.

In step 64, IDB capture software 38 displays a prompt to the customer to enter information identifying the airline customer. Example identifying information may include a confirmation number, a name, and/or a flight number. The customer may enter identifying information through one or more peripherals of computer 14.

In one example embodiment, the customer enters the identifying information using a touch screen. For example, IDB capture software 38 may display one or both of a keyboard and drop down list for entering or selecting a flight number, a date, and a customer name using the touch screen.

In another example embodiment, the customer enters the identifying information using a card reader. For example, IDB capture software 38 may display a prompt to swipe a loyalty or payment card. IDB capture software 38 obtains a customer name from the card through the card reader.

In another example embodiment, the customer enters the identifying information using a barcode reader. For example, IDB capture software 38 may display a prompt to scan a barcode on a boarding pass previously issued to the customer. The boarding pass may include a printed boarding pass or an e-boarding pass stored within a mobile communication device of the customer. IDB capture software 38 obtains a customer name, flight number, date and other information helpful to the airline from the barcode in the boarding pass through the barcode reader.

In another example embodiment, the customer enters the identifying information using a near field communication device. For example, IDB capture software 38 may display a prompt to place a customer's mobile communication device within communication range of the near field communication device of computer 14 and transmit the identifying information from the mobile communication device. IDB capture software 38 obtains a customer name from the mobile communication device through the near field communication device.

In another example embodiment, the customer enters the identifying information using a passport reader. For example, IDB capture software 38 may display a prompt to insert a customer's passport into a passport reader of computer 14. IDB capture software 38 obtains a customer name from the machine readable zone of the passport or a chip in the passport through the passport reader.

In step 66, IDB capture software 38 compares the customer provided identifying information against information in flight data 30 and/or passenger data 32 to verify that the customer has in fact been affected by an involuntary denial of boarding.

In step 68, IDB capture software 38 displays forms containing a notice of airline obligations and the terms of a compensation award offered to the customer and prompts the customer to enter an electronic signature.

The electronic signature may be a signature applied via a stylus, the customer's typed name, or other entry signifying the customer's agreement with the terms of the compensation award.

In step 70, IDB capture software 38 captures the electronic signature and stores signed forms in IDB data 34.

In step 72, IDB capture software 38 displays options for receiving the compensation award and prompts the customer to make a selection.

In step 74, IDB capture software 38 records a customer selection and issues the compensation award in accordance with the selected option.

In one example embodiment, IDB capture software 38 electronically provides the compensation award by adding the award to passenger data 32.

In another example embodiment, IDB capture software 38 prints a document evidencing the award.

In another example embodiment, IDB capture software 38 credits an amount of the award to a credit or other payment card account of the customer.

In another example embodiment, IDB capture software 38 sends an electronic document evidencing the award to the customer's email address, and/or transfers the electronic document to the customer's mobile communication device for storage through email, text message, near field communications, or other means.

Although the present invention has been described with particular reference to certain preferred embodiments thereof, variations and modifications of the present invention can be effected within the spirit and scope of the following claims.

What is claimed is:

1. A processor-implemented method programmed in a non-transitory processor-readable medium and to execute on one or more processors of a computer configured to execute the method, comprising:
displaying terms of a compensation award to a customer affected by involuntary denial of boarding by the computer;
recording an electronic signature of the customer by the computer; and
storing the terms and the electronic signature in a data store by the computer.

2. The method of claim 1, further comprising:
issuing the compensation award in accordance with the terms.

3. The method of claim 1, further comprising:
obtaining information identifying the customer from the customer; and
verifying that the customer was affected by involuntary denial of boarding.

4. The method of claim 3, wherein obtaining comprises:
obtaining the information as the customer enters the information via a touch screen of the computer.

5. The method of claim 3, wherein obtaining comprises:
obtaining the information from a card of the customer via a card reader of the computer.

6. The method of claim 3, wherein obtaining comprises:
obtaining the information from a passport of the customer via a passport reader of the computer.

7. The method of claim 3, wherein obtaining comprises:
obtaining the information from a mobile communication device of the customer via a near field communication reader of the computer.

8. The method of claim 3, wherein obtaining comprises:
obtaining the information from a barcode on a customer document via a barcode reader of the computer.

9. The method of claim 2, wherein issuing comprises:
adding the award to a customer record.

10. The method of claim 2, wherein issuing comprises:
crediting an amount of the award to a payment card account of the customer.

11. The method of claim 2, wherein issuing comprises:
transferring the award to a mobile communication device of the customer.

12. The method of claim 2, wherein issuing comprises:
sending a message containing the award to a customer address.

13. The method of claim 2, wherein issuing comprises:
printing a document evidencing the award via a printer of the computer.

14. The method of claim 1, wherein the computer comprises a self-service computer.

15. A processor-implemented method programmed in a non-transitory processor-readable medium and to execute on one or more processors of a self-service computer configured to execute the method, comprising:
receiving identifying information from a customer by the self-service computer;
comparing the identifying information to customer records by the self-service computer;
determining using the identifying information that the customer was involuntarily denied boarding;
displaying terms of a compensation award to the customer by the self-service computer;
recording by the self-service computer an electronic signature of the customer indicating acceptance of the terms of the compensation award;
issuing the compensation award to the customer in accordance with the terms by the self-service computer; and
storing the terms and the electronic signature in a data store by the self-service computer.

16. A self-service computer comprising:
a display;
an input device;
at least one processor; and
at least one memory comprising computer program code, the at least one memory and the computer program code configured to, with the at least one processor, cause the self-service computer at least to:
receive identifying information from a customer via the input device;
compare the identifying information to customer records;
determine using the identifying information that the customer was involuntarily denied boarding;
display terms of a compensation award to the customer;
record an electronic signature of the customer indicating acceptance of the terms of the compensation award;
issue the compensation award to the customer in accordance with the terms; and
store the terms and the electronic signature in a data store.

17. The self-service computer of claim 16, wherein the input device comprises a card reader for reading a customer card containing the identifying information.

18. The self-service computer of claim 16, wherein the input device comprises near field communication circuitry for obtaining the identifying information from a mobile communication device of the customer.

19. The self-service computer of claim 16, wherein the input device comprises a barcode reader for reading a barcode containing the identifying information on a customer document.

20. The self-service computer of claim 16, wherein the input device comprises a passport reader for obtaining the identifying information from a passport of the customer.
